(19) United States
(12) Patent Application Publication
(10) Pub. No.: US 2008/0177463 A1
(43) Pub. Date: Jul. 24, 2008

(54) Automobile navigation system

(75) Inventor: Kenichi Hamaguchi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/007,914

(22) Filed: Jan. 17, 2008

(30) Foreign Application Priority Data
Jan. 22, 2007 (JP) 2007-11545

(51) Int. Cl. G01C 21/36

(52) U.S. Cl. 701/201; 701/200; 701/206

(57) ABSTRACT

With respect to a destination set by a user, a control circuit of an automobile navigation system records the number of visits to the destination and information about the situation in which the user visited there. With respect to those of the recorded destinations conforming to the situation in which a predetermined trigger signal is supplied, the control circuit carries out the following processing: it computes priorities based on the numbers of visits classified by items of the situation; and it presents to the user information for choosing a destination of his/her subsequent driving by displaying it on a display unit based on the levels of the computed priorities.

### CROSS REFERENCE TO RELATED APPLICATION

This application is based on and incorporates herein by reference Japanese Patent Application No. 2007-11545 filed on Jan. 22, 2007.

### FIELD OF THE INVENTION

The present invention relates to an automobile navigation system that presents information on a visit point or destination so that a user can consult it when he/she chooses a visit point or destination.

### BACKGROUND OF THE INVENTION

There have been proposed various techniques for carrying out the following when a user sets a destination with an automobile navigation system: destination candidates estimated to be appropriate are presented to facilitate his/her choice. For example, Patent Document 1 discloses a technique for displaying those retrieved in the past with respect to administrative areas at inputted addresses. Patent Document 2 discloses a technique for implementing the following: schedule information indicating scheduled times of arrival at multiple destinations is taken in through communication with a server on-a network; and a route going through them is computed based on the schedule information. Patent Document 3 discloses a technique for automatically giving notice when a vehicle approaches a place where a user has been in the past.

Patent Document 1: JP-A-2004-184563 (corresponding to U.S. Pat. No. 7,218,246)

Patent Document 2: JP-A-2001-147129

Patent Document 3: JP-A-2004-325148

The technique in Patent Document 1 is so constructed that when a user operates a history button, the latest one of destinations retrieved in the past is displayed or they are displayed in the form of list arranged in order of number of retrieval times or distance. For this reason, a problem arises. It takes some time for the user to choose an appropriate one from among these destinations.

The technique in Patent Document 2 poses another problem. A user can choose only destinations he/she previously entered into a schedule. Therefore, a destination the user desires to choose at a certain moment is not always contained in the schedule. If the destination is not contained, the user must enter it into the schedule anew. With the technique in Patent Document 3, a destination a user once visited is not notified unless his/her vehicle approaches the destination. The user cannot choose it beforehand.

### SUMMARY OF THE INVENTION

The present invention has been made in consideration of the foregoing, and it is an object of the present invention to provide an automobile navigation system capable of presenting information on a visit point or destination so that it more properly fits a user's behavioral pattern.

To achieve the above object, according to an example of the present invention, a navigation system for a vehicle is provided as follows. A visit information recording unit is configured to record each visit point included in a plurality of visit points visited by a user, the each visit point being recorded in association with (i) visit situation information about each visit situation item included in a plurality of visit situation items, in which the user visited the each visit point, and (ii) a visit number of times the user visited the each visit point in the each visit situation item. A priority computing unit is configured to (i) designate, from the recorded visit points, visit points associated with visit situation items conforming to a trigger situation in which a predetermined trigger signal is supplied and (ii) compute a priority for each of the designated visit points, based on a visit number of times with respect to each visit situation item included in the visit situation items conforming to the trigger situation. A visit point information presenting unit is configured to present, based on the computed priorities of the designated visit points, visit point information for the user to choose a visit point for a subsequent driving.

### BRIEF DESCRIPTION OF THE DRAWINGS

The above and other objects, features, and advantages of the present invention will become more apparent from the following detailed description made with reference to the accompanying drawings. In the drawings:

FIG. 1 is a functional block diagram illustrating a configuration of an automobile navigation system in a first embodiment of the present invention;

FIG. 2 is a flowchart of destination information file update processing carried out by a control circuit of the automobile navigation system;

FIG. 3 is a flowchart illustrating month file update processing;

FIG. 4A is a drawing illustrating an example of a month file;

FIG. 4B is a drawing illustrating an example of a day of the week file;

FIG. 4C is a drawing illustrating an example of a period of time file;

FIG. 5 is a flowchart of situation priority determination processing;

FIG. 6 is a drawing illustrating an example of a candidate place file;

FIG. 7 is a flowchart of ultimate priority determination processing;

FIG. 8 is a drawing equivalent to FIG. 6, with ultimate priorities computed;

FIG. 9A is an example of a screen image for inputting destination setting in a display unit;

FIG. 9B is a example of a screen image in which candidate places are displayed in the form of list;

FIG. 10 is a flowchart of information presentation processing in a second embodiment of the present invention;

FIG. 11 is an example of a screen image of a display unit illustrating an example of the result of execution of information presentation processing;

FIG. 12A is a drawing illustrating a third embodiment of the present invention, equivalent to FIG. 9B;

FIG. 12B is a drawing illustrating the third embodiment of the present invention, depicting an example of a screen image that appears when a user operates an “Add” operation button;

FIG. 13 is a drawing equivalent to FIG. 6;

FIG. 14 is a drawing illustrating the positional relation between the present position of a vehicle, a set destination, and points X, Y, and Z;

FIG. 15 is a flowchart of intermediate point priority determination processing;

FIG. 16 is a drawing equivalent to FIG. 6, related to intermediate point candidates;

FIG. 17 is a drawing equivalent to FIG. 9B;

FIG. 18 is a flowchart of ultimate destination priority determination processing;

FIG. 19 is a drawing equivalent to FIG. 6, related to ultimate destination candidates; and

FIG. 20 is a drawing equivalent to FIG. 9B.

### DETAILED DESCRIPTION OF THE PREFERRED EMBODIMENTS

### First Embodiment

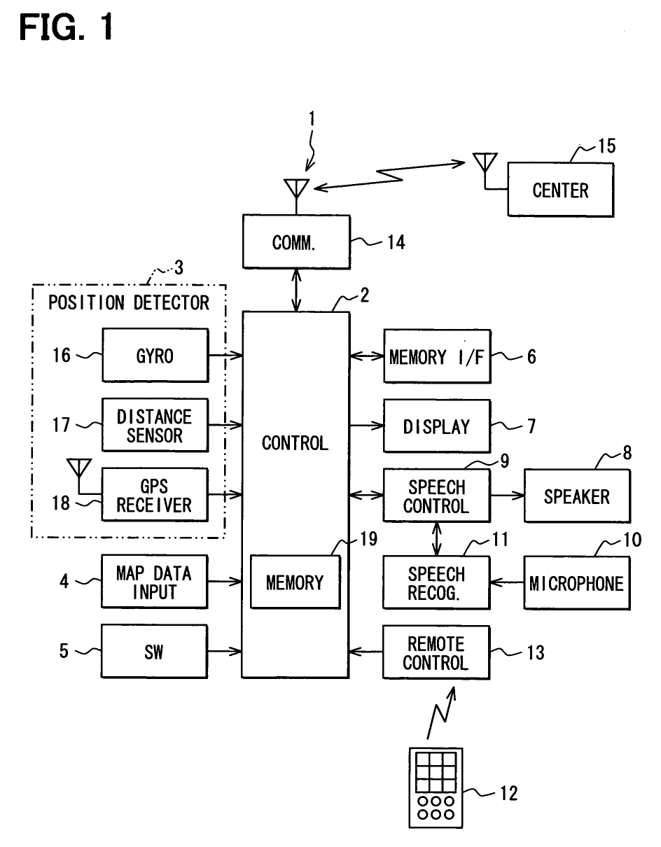

Hereafter, description will be given to a first embodiment of the present invention with reference to FIG. 1 to FIG. 9B. FIG. 1 is a functional block diagram illustrating the configuration of an automobile navigation system 1 mounted in a subject vehicle. The automobile navigation system 1 includes: a control circuit 2 (functioning as a visit information recording means or unit, priority computing means or unit, or visit point information presenting means or unit) constructed based on a microcomputer; a position detector 3 (functioning as a position acquiring means or unit) for detecting the present position of a relevant vehicle; a map data input device (map database) 4; an operation switch group 5; an external memory interface (I/F) 6; a display unit 7 (functioning as a displaying means) constructed of a color liquid crystal display or the like; a speech controller 9 connected with a speaker (functioning as a notifying means or unit) 8; a speech recognition device 11 for recognizing speech inputted through a microphone 10; a remote controller sensor 13 for transmitting and receiving commands and the like to and from a remote controller 12; and a communication device 14 (e.g., cellular phone, automobile telephone, FM multiple receiver, beacon for VICS (registered trademark representing Vehicle Information and Communication System), etc.) for transmitting and receiving data to and from, for example, a VICS center 15 and various information centers by radio communication.

The position detector 3 includes: a gyro scope 16 for detecting the rotational angle speed of the vehicle; a distance sensor 17 for detecting the travel distance of the vehicle; and a GPS receiver 18 for GPS (Global Positioning System) for detecting (measuring) the present position of the vehicle based on radio waves transmitted from artificial satellites. These sensors 16 to 18 have errors different in nature. Therefore, the control circuit 2 uses the detection values from the sensors 16 to 18 in a complementary manner to detect the present position, traveling direction, speed, and travel distance of the vehicle, the current time, and the like with accuracy. Depending on required accuracy, the position detector 3 may be constructed of only some of the above-mentioned sensors 16 to 18. Or, a rotation sensor for steering, a wheel sensor for each wheel, and the like may be used.

The map data input device 4 is constructed of a drive unit for reading data from a map data recording medium. Map data recording media are used to record varied data including road map data, landmark data, map matching data, destination data (facility database), table data for converting traffic information into road data, and the like. As map data recording media, mass storage media such as DVD are generally used; however, such media as memory card, hard disk, and the like may be used.

The road map data includes data on road shape, road width, road names, traffic lights, railroad crossings, buildings, various facilities, place names, geography, and the like. Further, it includes data for displaying a road map on the screen of the display unit 7. When there is regulation such as one-way traffic-and the prohibition of entry with respect to some road, information about the traffic regulation is recorded together.

The destination data is composed of information concerning facilities including transport facilities, such as stations, leisure facilities, accommodation facilities, and community facilities, various stores including retails shops, department stores, and restaurants, residences and apartment buildings, place names, and the like. This data includes data concerning the phone number and address and the latitude and longitude of each of the above facilities, and data for displaying landmarks and the like indicating facilities over the road map on the screen of the display unit 7.

The operation switch group 5 as an inputting means or unit includes mechanical switches provided in proximity to the screen of the display unit 7 and a touch panel provided over the screen of the display unit 7. A user (driver) uses the operation switch group 5 to input the following: a visit point such as a destination or intermediate point (stopping point, or way point), information (destination search condition) required for searching for the visit point; and various commands for changing the display screen image of the display unit 7 and a display mode (changing a map scale, selecting a menu display, searching for a route, starting route guidance, correcting the present position, controlling the volume, and the like). The remote controller 12 is provided with multiple operation switches, and various command signals are transmitted from the remote controller 12 to the control circuit 2 via the remote controller sensor 13 through switch operation. The control circuit 2 can be caused to carry out the same functions whichever, the operation switch group 5 or the remote controller 12, is operated.

The external memory I/F 6 accommodates to memory media, for example, flash memory cards. With respect to automobile navigation, it is used to write data into a recording medium, such as a memory card, and store it. Examples of such data include data on a route to a destination set by the control circuit 2 in route guidance and data on a route through which the vehicle has passed.

The screen of the display unit 7 (displaying means) shows a map of the area in proximity to the position of the vehicle to various scales. Further, it shows a present location mark (pointer) indicating the present position and traveling direction of the vehicle over the displayed map image. When route guidance to a destination is carried out, a display screen image for route guidance is displayed. Further, the screen shows a display screen image for the user to input information or the like required for destination search, a display screen image for input to search for or set a destination, various messages, and the like.

The speech recognition device 11 checks a speech inputted through the microphone 10 against internally stored dictionary data for recognition and recognize the inputted speech. The speech controller 9 controls the speech recognition device 11 to outputs the results of speech recognition to the control circuit 2 and outputs recognized speech through the speaker 8 by talk back. Further, it outputs a speech output signal to the speaker 8 according to a speech output command from the control circuit 2. The speeches outputted from the speaker 8 include a speech related to guidance, speech related to operating instruction, the above talk back speech, and the like.

The microcomputer constructing the control circuit 2 includes CPU, memory (RAM, ROM, EEPROM, flash memory, etc.) 19, I/O, and the like. The CPU executes a program stored in the ROM (or flash memory), and this causes the control circuit 2 to function as a destination setting means or unit, route searching means or unit, display controlling means or unit, route guidance means or unit, or the like. The functions of the route searching means or unit are used to automatically compute a recommended traveling route from the departure place (present position) of the vehicle to a destination, and an example of techniques for the purpose is the Dijkstra method.

The functions of the route guidance means are used to implement the following so that the vehicle can move along a traveling route: a road map of the area in proximity to the present location is displayed on the screen of the display unit 7; and the present location mark indicating the present position and traveling direction of the vehicle is displayed over a road map. As the vehicle runs, the indication of the present location is moved on the map, and the displayed map is scrolled according to the position of the vehicle. At this time, map matching is carried out to place the present location of the vehicle on a road.

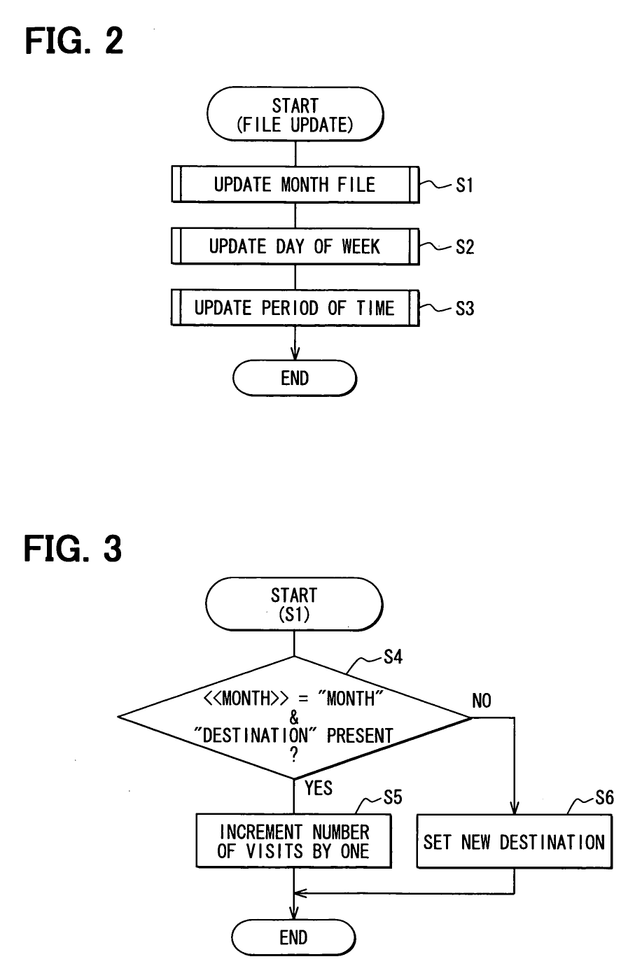

Description will be given to the action of this embodiment with reference to FIG. 2 to FIG. 9B as well.

<File Update Processing>

FIG. 2 is a flowchart of destination information file update processing carried out by the control circuit 2 of the automobile navigation system 1. The destination information file is used for the following purpose: a situation in which a user sets a destination with the automobile navigation system 1 is broken down into multiple items, and the number of visits to the destination is stored into the memory 19 on an item-by-item basis. Thus, the memory 19 serves as a recording means or unit for information on visits, destinations, visit points, and their associated items. Examples of these items include “month,” “day of the week,” “period of time,” and the like. The control circuit 2 carries out the file update processing illustrated in FIG. 2 on the following occasions, for example: when the user inputs and sets a destination, when or after the vehicle arrives at a set destination, or when the engine is stopped. Then, the control circuit updates a month file, a day of the week file, and a period of time file in succession (Steps S1 to S3).

For example, the month file is composed of “month,” “candidate place address,” and “number of visits.” The “month” represents any of January to December; the “candidate place address” represents a storage address corresponding to a destination chosen and set in the past (future candidate place); and the “number of visits” represents a number of times that a destination was set, that the vehicle arrived at a destination, or that the vehicle arrived at a destination and the engine of the vehicle was turned off according to the execution timing of the above file update processing. The day of the week file and the period of time file are composed similarly with the month file. The “day of the week” represents any of Sunday to Saturday, and the “period of time” (or time zone) represents, for example, morning or afternoon.

FIG. 3 is a flowchart illustrating the flow of the processing of updating the month file at Step SI. First, the control circuit 2 determines whether or not the above “destination” exists in the file of <<month>> identical with the “month” when the destination was chosen (Step S4). When the “destination” exists (YES), the <<number of visits>> to the <<candidate place>> corresponding to the “destination” in the <<month>> file is incremented (Step S5). When the “destination” does not exist (NO), an address corresponding to the new “destination” is set in the <<candidate place>> in the above <<month>> file and the <<number of visits>> is set to “1” (Step S6). The processing of updating the day of the week file and the period of time file is also carried out as illustrated in FIG. 3.

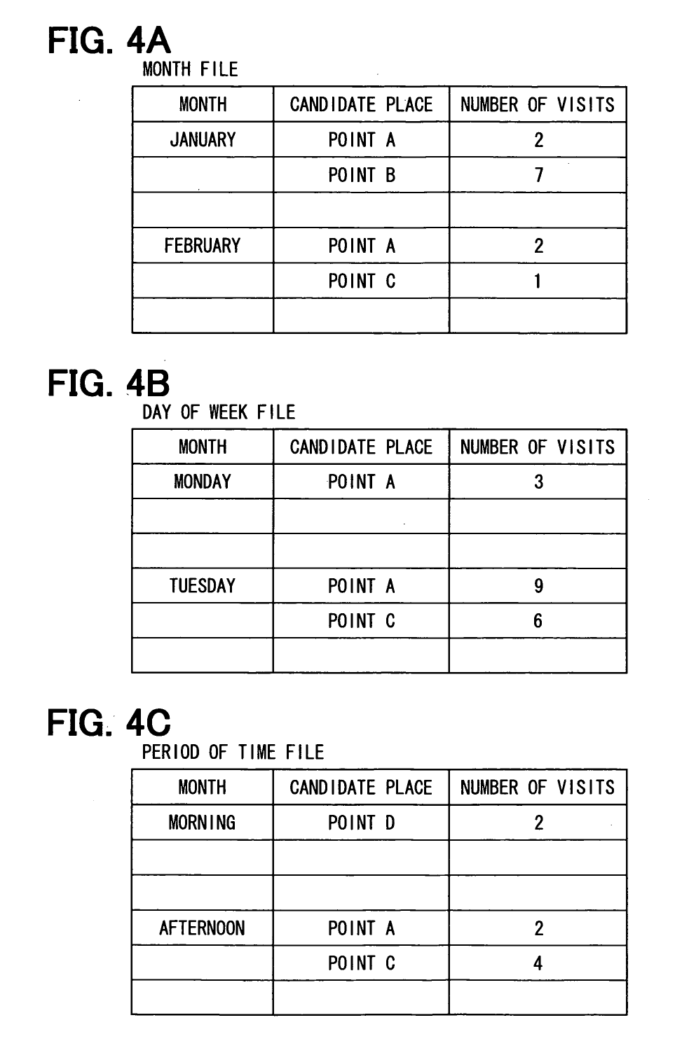

The drawings from FIG. 4A to FIG. 4C illustrate examples of the month file, day of the week file, and period of time file. As an example, it will be assumed that each file is in the state illustrated in FIG. 4A to FIG. 4C and the user goes to point “A” in the “morning of January 13 (Mon), 200x.” When the file update processing in FIG. 2 is executed in this case, <<number of visits>> to <<point A>> in <<January>> in the month file is incremented to <<3>> (Step S1). <<number of visits>> to <<point A>> on <<Monday>> in the day of the week file is incremented to <<4>> (Step S2). Since <<point A>> does not exist under the item <<morning>> in the period of time file, <<point A>> is newly set and the corresponding <<number of visits>> is set to <<1>> (Step S3).

<Computation of Situation Priority>

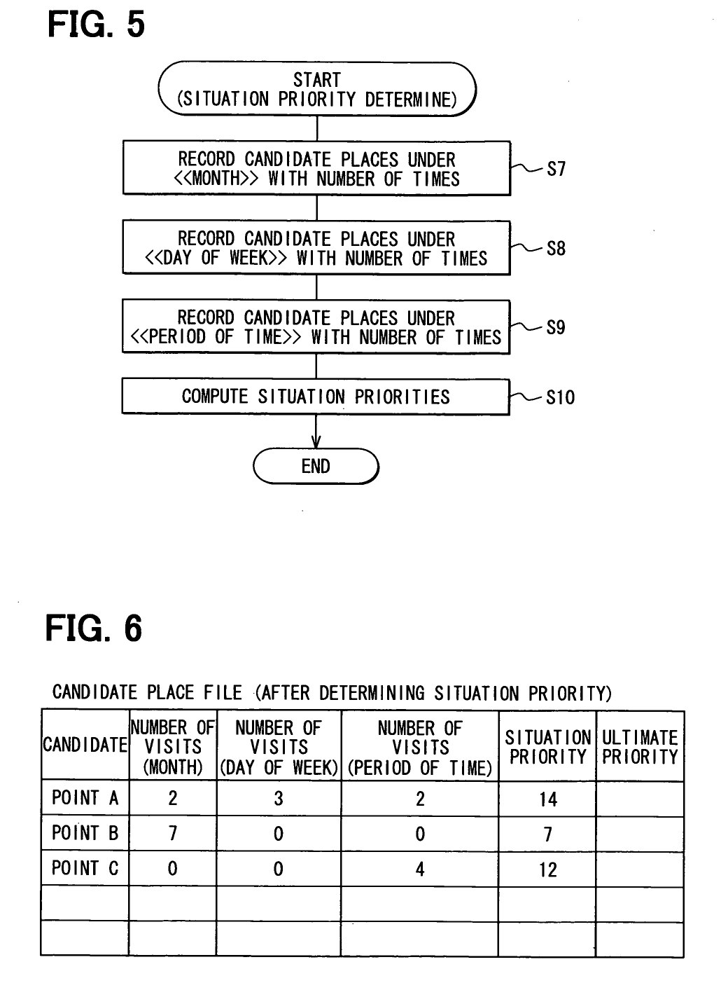

When the situation priority determination processing illustrated in FIG. 5 is executed, the situation priority of each candidate place is determined based on the respective file data of month, day of the week, and period of time. Then, a candidate place file is updated as illustrated in FIG. 6. The situation priority determination processing in FIG. 5 is carried out, for example, when the user starts the engine of the vehicle or when a change comes out in any situation item while the vehicle is running. That is, any one of them is supplied as a trigger signal for carrying out the above processing.

As an example, it will be assumed that each file is in the state illustrated in FIG. 4A to FIG. 4C and the user gets in the vehicle and starts its engine in the “morning of January 20 (Mon), 200x.” In the flow illustrated in FIG. 5, at this time, all the candidate places existing under <<January>> in the month file are stored under <<candidate place>> and <<number of visits (month)>> in the candidate place file (Step S7).

Then, all the candidate places existing under <<Monday>> in the day of the week file are stored under <<candidate place>> and <<number of visits (day of the week)>> in the candidate place file (Step S8). All the candidate places existing under <<morning>> in the period of time file are stored under <<candidate place>> and <<number of visits (period of time)>> in the candidate place file (Step S9). Subsequently, the situation priority of every candidate place in the candidate place file is computed by Expression (1), and the results of computation are stored in the candidate place file (Step S10).

(Situation priority)=a×(number of visits (month))+β×(number of visits (day of the week))+γ×(number of visits (period of time)) (1)

where α, β, and γ are weighting factors respectively set for number of visits (month), number of visits (day of the week), and number of visits (period of time). When α=1, β=2, and γ=3, the results of situation priority computation and the candidate place file are as illustrated in FIG. 6. That is, the situation priorities of point A, point B, and point C are respectively <<14>>, <<7>>, and <<12>>.

That is, the information recorded in the candidate place file indicates in what situation (month, day of the week, period of time) the user frequently chose destinations he/she visited in the past. Therefore, the situation priority of a destination is so computed that it is higher with increase in number of visits in conformity to the situation at the time when a trigger signal is supplied and computation is carried out. As a result, a situation priority that is more properly matched with the user's behavioral pattern is set higher.

<Computation of Ultimate Priority>

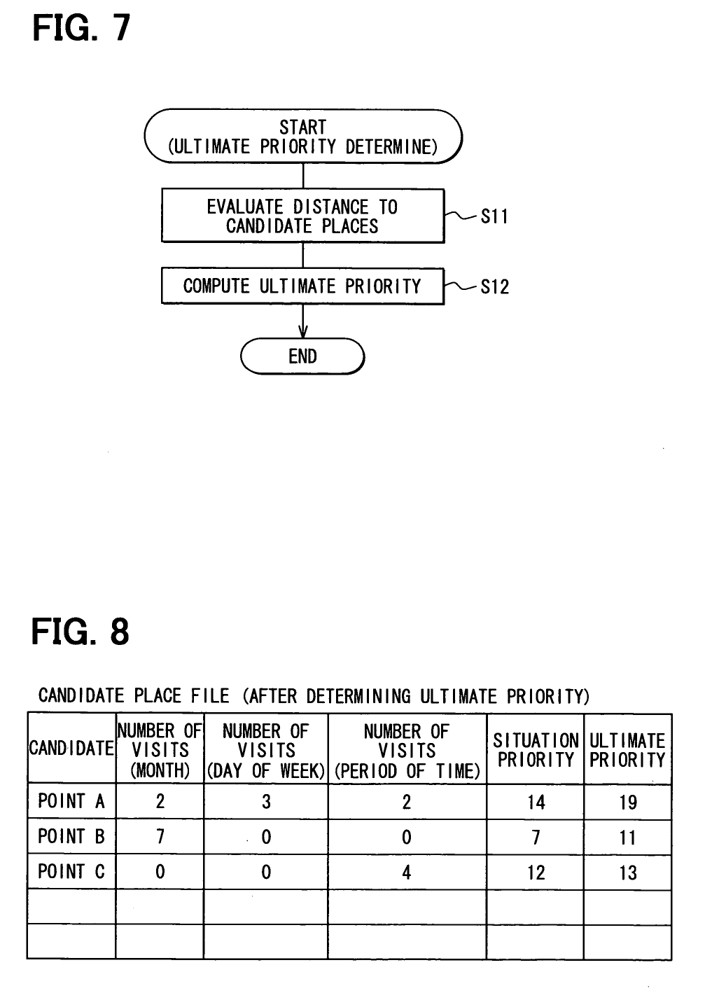

Then, the control circuit 2 computes ultimate priorities based on the situation priority of each <<candidate place>> and the distance between the present position of the vehicle and each <<candidate place>> in accordance with the flowchart illustrated in FIG. 7. The processing in FIG. 7 is carried out, for example, when the user performs input operation to set a destination or constantly when the control circuit 2 is not carrying out any other processing. All the candidate places in the candidate place file or some selected from among <<candidate places>> whose situation priority is highly ranked may be subjected to the ultimate priority computation. In case of the latter, it is possible to limit the number of objects of computation and shorten a processing time.

In the flow illustrated in FIG. 7, the control circuit 2 computes the distance between each <<candidate place>> subjected to computation and the present position (Step S11). The “distance” computed here need not be exact, and it only has to make it possible to relatively evaluate lengths. Further, “distance” is treated as a non-dimensional number. Therefore, for example, the square sum of the distance between the x-coordinates xl of them and the distance between the y-coordinates yl of them is computed. (When there is a margin of processing, the square root of the square sum may be computed.)

“Distance”=xl²+yl² (2)

Subsequently, the control circuit 2 computes ultimate priorities from the distance (evaluation value) of each <<candidate place>> computed at Step S11 and situation priorities by Expression (3) and the results of computation are recorded in the candidate place file (Step S12).

(Ultimate priority)=φ×(situation priority)+ψ/“distance” (3)

where, φ and ψ are weighting factors respectively set for situation priority and “distance.” For example, when the “distance” to point A=40, the “distance” to point B=50, the distance to point C=200, φ=1, and Ω=200, the results of ultimate priority computation and the candidate place file are as illustrated in FIG. 8. That is, the situation priorities of point A, point B, and point C are respectively <<19>>, <<11>>, and <<13>>.

<Information Presentation to User>

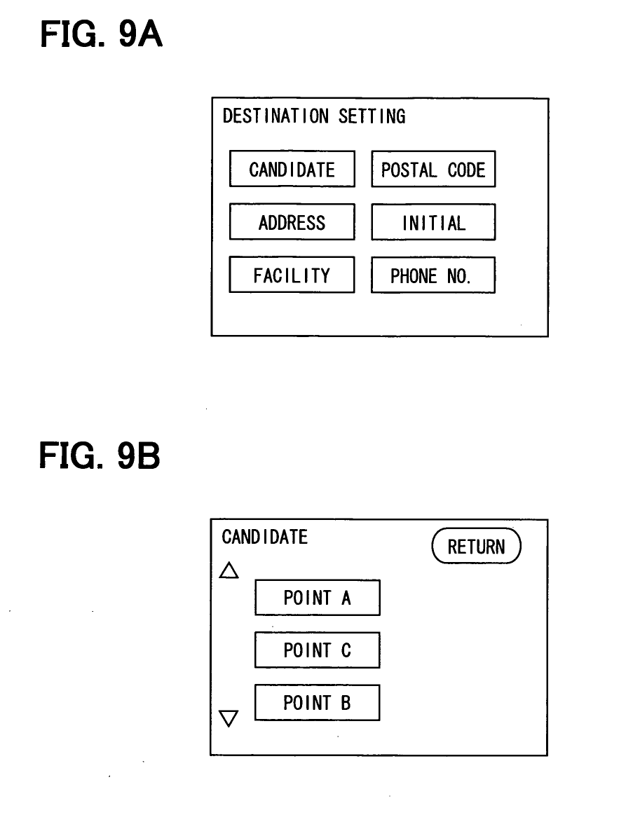

FIG. 9A is an example of a display screen image for inputting and setting a destination in the display unit 7 of the automobile navigation system 1. For example, the display screen image shows items of “candidate place,” “address,” “facility,” “postal code,” “initial,” “phone number,” and the like. When the user chooses a “candidate place” by any of them, the control circuit 2 displays <<candidate places>> in the candidate place file in descending order of ultimate priority in the form of list as illustrated in FIG. 9B. That is, since the ultimate priority descends in order of A>C>B, the candidate places are displayed in this order.

In this embodiment, as mentioned above, the control circuit 2 of the automobile navigation system 1 records the following with respect to a destination set by the user: the number of times that he/she visited the destination and information related to the situation in which he/she visited there. With respect to those of the recorded destinations conforming to the situation in which a predetermined trigger signal was supplied, the control circuit carries out the following processing: it computes priorities based on numbers of visits classified by item of the situation, and presents to the user information for him/her to choose a destination of his/her subsequent driving based on the levels of the computed priorities.

The priorities computed as mentioned above are higher as they are more properly matched with the user's behavioral pattern. Therefore, when information for choosing a destination is presented according to the levels of priorities, there is a higher possibility that the user thinks the destination candidates to conform to the situation at that time. As a result, the user can easily choose a destination more properly matched with his/her own behavioral pattern. More specific description will be given. The above information includes the month, day of the week, period of time when the above destination was set. Therefore, recorded information about destinations can indicate a tendency for the user about the number of visits with respect to each month, day of the week, and period of time. Priorities can be computed based on these pieces of information.

Since situation priorities are computed by Expression (1), they can be computed so that the levels of the situation priorities are determined according to weights respectively set for the individual situation items. Since ultimate priorities are computed by Expression (3), it is possible to take into account the distance to each candidate place whose situation priority is to be computed as well, and more appropriately set priorities. Further, when a request to present destination candidates is inputted by the user, the control circuit 2 displays the destination candidates in descending order of priority in the form of list on the display unit 7. Therefore, the user can choose a destination he/she should choose from the list.

### Second Embodiment

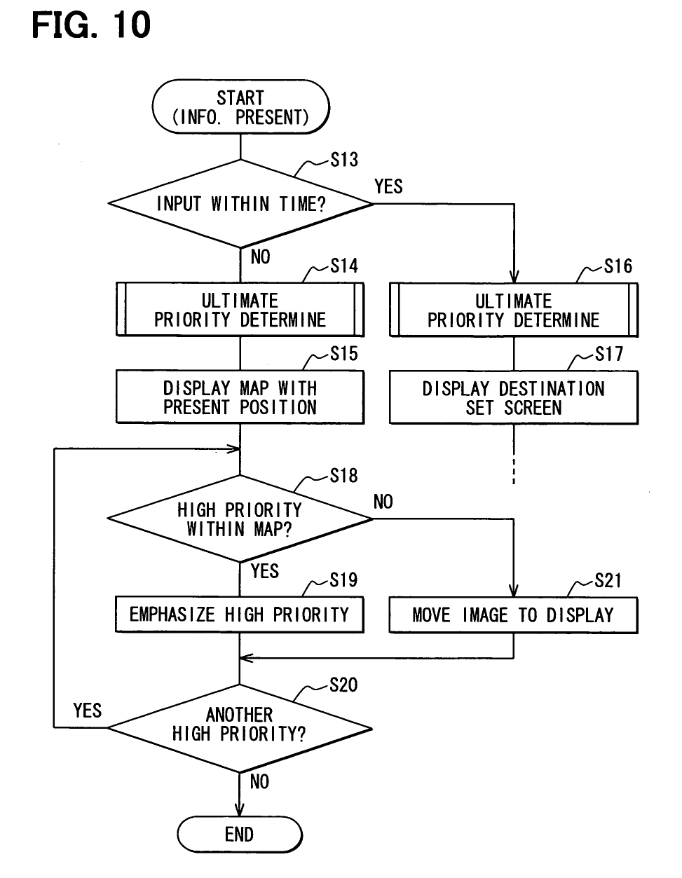

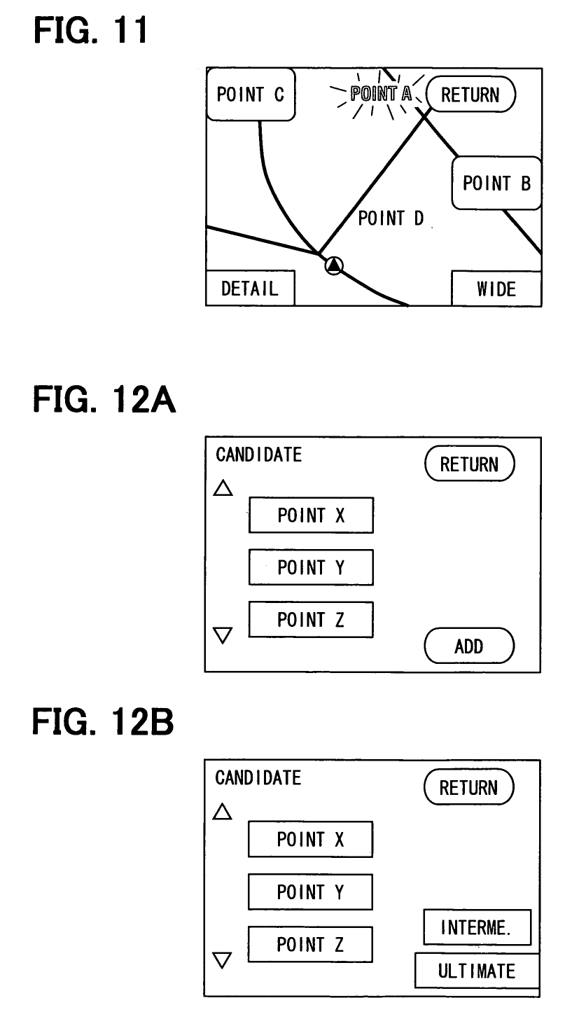

The drawings from FIG. 10 and FIG. 11 illustrate a second embodiment of the present invention. The same members as in the first embodiment will be marked with the same reference numerals, and the description of them will be omitted. Hereafter, description will be given only to a difference from the first embodiment. In the second embodiment, the processing up to the ultimate priority computation is carried out as in the first embodiment. The mode for presenting a candidate place based on the result of computation is different from the first embodiment. In the flow of the information presentation processing illustrated in the flowchart of FIG. 10, the control circuit 2 carries out the processing described below. When the power to the automobile navigation system 1 is turned on and it is started, the control circuit 2 determines whether or not the user performs input operation to set a destination within a predetermined time (e.g., one minute or so) (Step S13). When this input operation is performed (YES), the control circuit executes the ultimate priority determination processing in FIG. 7 (Step S16) and then displays the destination setting screen illustrated in FIG. 9A (Step S17). The subsequent processing is carried out as in the first embodiment.

When the above input operation is not performed within the predetermined time (NO), that becomes a trigger signal. The control circuit executes the ultimate priority determination processing as at Step S16 (Step S14) and then displays a map display screen image embracing the present position of the vehicle on the display unit 7 (Step S15). Then, it determines whether or not a <<candidate place>> whose ultimate priority was computed at Step S14 is highly ranked exists in the coverage of the map screen image displayed at Step S15 (Step S18). When it exists (YES), the <<candidate place>> is displayed on the map screen image in an emphasized manner (Step S19).

When it is determined at Step S18 that the <<candidate place>> whose ultimate priority was highly ranked does not exist in the coverage of the map screen image (NO), the following processing is carried out: the display screen image is moved to the direction in which the <<candidate place>> whose ultimate priority was highly ranked is positioned out of the map to thereby display the <<candidate place>> on the screen (Step S21). The above-mentioned processing of Steps S18, S19, and S21 is repeated until there is not left a “candidate place” to be presented any more (Step S20: NO).

FIG. 11 is an example of a display screen image of the display unit 7, illustrating an example of the result of execution of the information presentation processing illustrated in FIG. 10. In this example, point A exists within the coverage of the map screen image and thus it is displayed in an emphasized manner. Point B and point C do not exist within the display screen image and the directions to Point B and Point C, which are positioned out of the screen image, are displayed. (The former is displayed at the right and the latter is displayed at the upper left.) Point D is low in ultimate priority. Though it is positioned within the display screen image; therefore, it is not displayed in an emphasized manner. The user can set any of points A to D as a destination by pointing it with a cursor or the like on the screen to perform setting input.

In the second embodiment, as mentioned above, the control circuit 2 carries out the following processing when a request to present destination candidates is not inputted by the user within a predetermined time after the automobile navigation system 1 is started: when a destination candidate whose priority is highly ranked exists on the map screen image displayed on the display unit 7 so that the present position of the vehicle is embraced, it displays the destination candidate in an emphasized manner. Therefore, even when the user does not expressly show a request to present destination candidates, the user can choose a destination candidate whose priority is highly ranked from the map screen image displayed at that time.

When a destination candidate whose priority is highly ranked cannot be displayed on the map screen image displayed on the display unit 7, the control circuit 2 displays the direction, in which the destination candidate is positioned, on the map screen image. Therefore, even when the user desires to choose a candidate positioned out of a screen image, he/she can choose it based on the display.

### Third Embodiment

The drawings from FIG. 12 to FIG. 20 illustrate a third embodiment of the present invention, and description will be given only to a difference from the first embodiment. The third embodiment is so constructed that the following is performed after a user once sets a destination based on information presented by the automobile navigation system 1: the user additionally sets an intermediate point (or stopping point) between the present position and the destination or the user takes the destination as an intermediate point and newly sets an ultimate destination as an ultimate point. FIG. 12A corresponds to FIG. 9B referred to in relation to the first embodiment. Once a destination is set, an operation button of “Add” is displayed on the screen of the display unit 7. The points X, Y, and Z displayed as candidates on the screen in the form of list at this time are high in ultimate priority, except the already set destination.

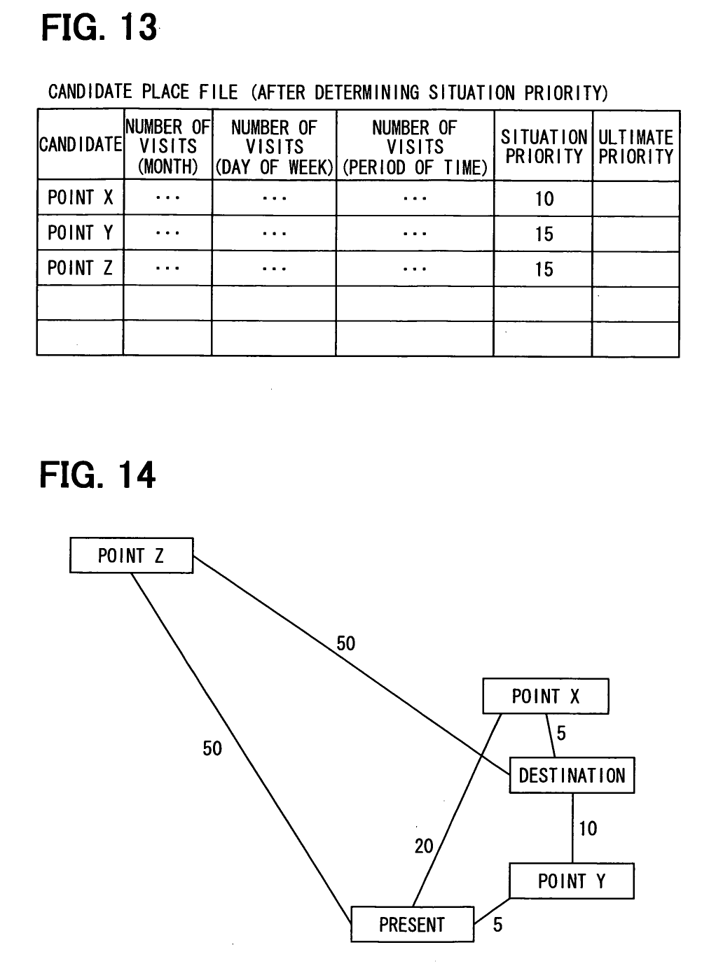

When the user operates the “Add” operation button from the screen illustrated in FIG. 12A, operation buttons of “Intermediate Point” and “Ultimate Destination” are displayed as illustrated in FIG. 12B. At this time, the situation priorities of points X, Y, and Z in the candidate place file are respectively <<10>>, <<15>>, and <<15>> as illustrated in FIG. 13. The positional relation between the present position of the vehicle, the set destination, and points X, Y, and Z is as illustrated in FIG. 14. The numeric values shown between these points represent “distances.”

<Setting of Intermediate Point>

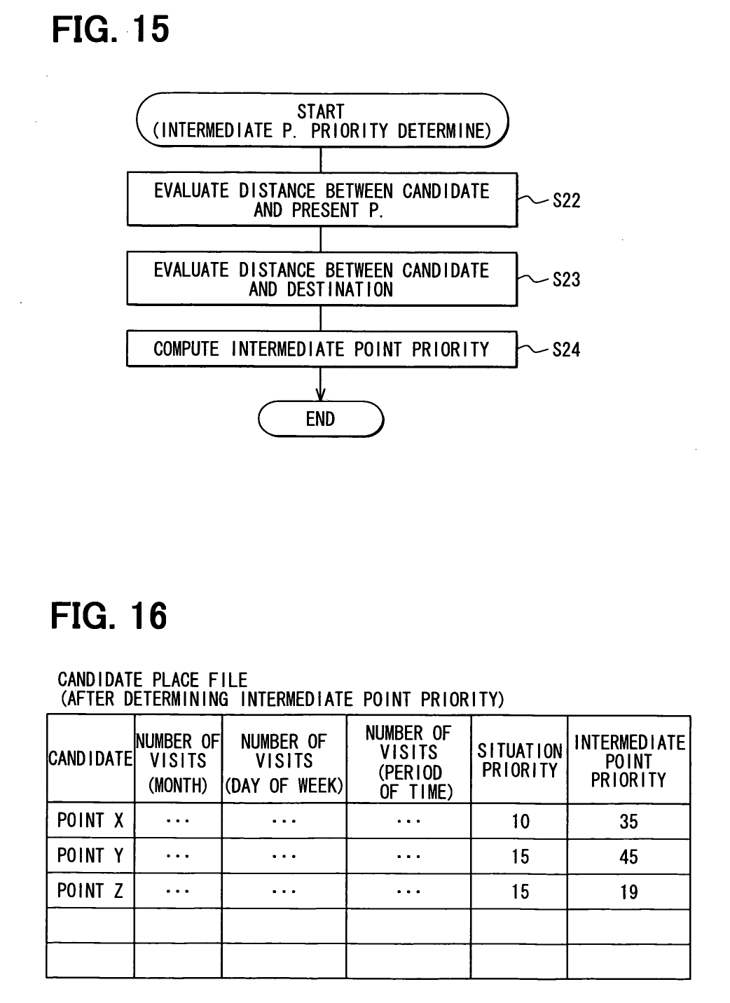

When the user operates the “Intermediate Point” operation button from the screen illustrated in FIG. 12B (trigger signal), the intermediate point priority determination processing illustrated in FIG. 15 is carried out. This corresponds to, for example, a case where an ultimate destination has been established but the user desires to deviate from the route thereto. The control circuit 2 determines the following distances in succession: “distance” (first distance) between each <<candidate place>> in the candidate place file and the present location; and “distance” (second distance) between each <<candidate place>> and the already set destination (Steps S22 and S23). It computes intermediate point-priorities from these “distances” and situation priorities by Expression (4) and records the results of computation into the candidate place file (Step S24).

(Intermediate point priority)=φ×(situation priority)+ψ/(first distance)+ε/(second distance) (4)

where, φ, ψ, and ε are weighting factors respectively set for situation priorities and “distances” (first distance and second distance).

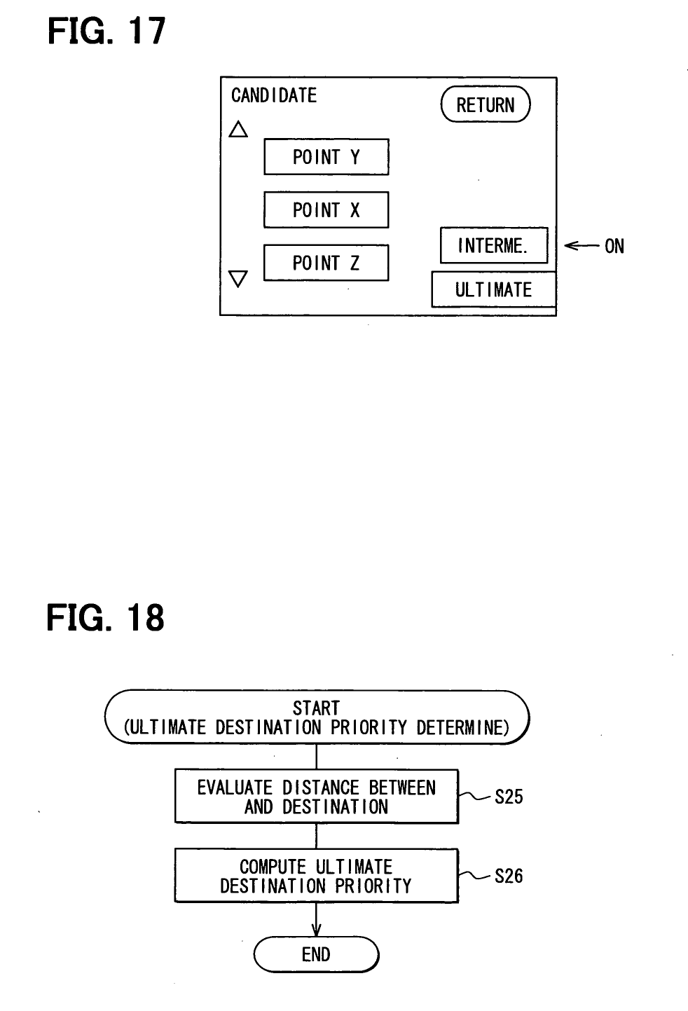

When the weighting factors are set as φ=1, ψ=100, and ε=100 for the respective distances between the points illustrated in FIG. 14, for example, the results of intermediate point priority computation and the candidate place file are as illustrated in FIG. 16. That is, the intermediate point priorities of point X, point Y, and point Z are respectively <<35>>, <<45>>, and <<19>>. As a result, the candidate places of intermediate point are displayed in the form of list in the order of point Y, point X, and point Z according to the level of intermediate point priority as illustrated in FIG. 17.

<Setting of Ultimate Destination>

When the user operate the “Ultimate Destination” operation button from the screen illustrated in FIG. 12B (trigger signal), the ultimate destination priority determination processing illustrated in FIG. 18 is carried out. This corresponds to, for example, a case where the user desires to take an already set destination as an intermediate point and set an ultimate destination therebeyond. The control circuit 2 determines the “distance” between each <<candidate place>> in the candidate place file and the already set destination (Step S25). Then, it computes ultimate destination priorities from these “distances” and situation priorities by Expression (5) and records the results of computation into the candidate place file (Step S26).

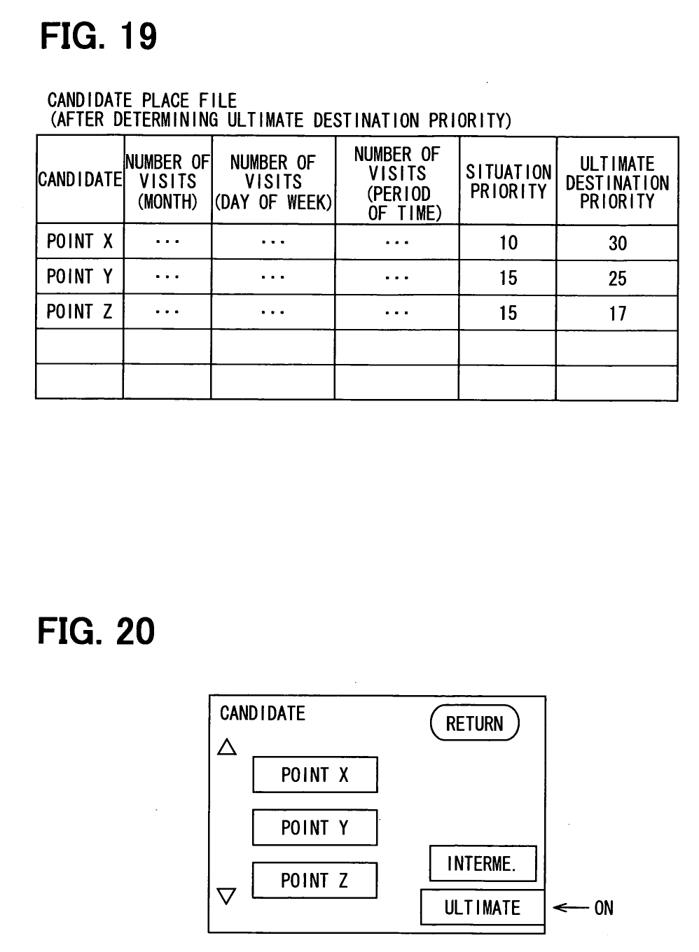

(Ultimate destination priority)=φ×(situation priority)+ψ/“distance” (5)

where, φ and ψ are weighting factors respectively set for situation priorities and the “distances” to the already set destination. When the weighting factors are set as φ=1 and ψ=100 for the respective distances between the points illustrated in FIG. 14, for example, the results of ultimate destination priority computation and the candidate place file are as illustrated in FIG. 19. That is, the ultimate destination priorities of point X, point Y, and point Z are respectively <<30>>, <<25>>, and <<17>>. As a result, the candidate places of ultimate destination are displayed in the form of list in the order of point X, point Y, and point Z according to the level of ultimate destination priority as illustrated in FIG. 20.

As in the first embodiment, all the candidate places in the candidate place file may be subjected to intermediate point priority and ultimate destination priority computations, or some selected from among <<candidate places>> whose situation priority is highly ranked may be subjected thereto.

In the third embodiment, as mentioned above, the control circuit 2 computes intermediate point priorities by Expression (4) when a request to present destination candidates (intermediate point candidates) is newly inputted by the user after he/she sets a destination once. Therefore, information about intermediate point candidates can be appropriately presented to the user based on the priorities. Further, the control circuit 2 computes ultimate destination priorities by Expression (5) when a request to present destination candidates (ultimate destination candidates) is newly inputted by the user to set an ultimate destination. Therefore, information about ultimate destination candidates can be appropriately presented to the user based on the priorities.

The present invention is not limited to the above embodiments described with reference to the drawings, and can be modified as described below.

The second embodiment and the third embodiment may be combined with each other, and intermediate point candidates and ultimate destination candidates may be presented to the user so that they are displayed over a map screen image.

Information about each candidate place may be presented to the user by outputting a speech message.

Ultimate priorities need not be determined from situation priorities. Instead, “distances” may also be included in priority computation from the beginning. In this case, the weighting factor φ in Expression (3) is unnecessary.

The order of information presentation may be determined according to the level of situation priority without determining ultimate priorities.

The weighting factors in the above embodiments may be modified as required. These factors may be supplied as fixed values, or may be updated so that they are optimized by carrying out learning based on the result of the user's actually setting a destination. In case of the latter, priorities can be corrected so that they take a value incorporating the result of the user's actual choice, and the user can feel comfortable in use.

The computational expressions for the individual priorities need not be the same as described in relation to the above embodiments. For example, a Cobb-Douglas function or the like may be used.

The month, day of the week, and period of time files may be so set that the priority of a <<candidate place>> for which the number of visits is set to a value not less than 1 is set higher.

The structure of each of the above files is arbitrary, and one file containing all the items may be constructed.

Each data may be-managed as a variable without constructing a candidate place file.

With respect to the time when priorities are updated through computation, the following measure may be taken: they are updated at the discretion of the user, or the update time is optimized through learning.

With respect to priority, the weighting factors other than that for “distance” may be set to “0.” In this case, candidate places can be presented in increasing order of distance from the present location or to an already set destination.

The present invention may be so constructed that the following is implemented: when a starting signal for the engine is supplied from the vehicle side, that is taken as a trigger signal and the destination candidate whose priority becomes highest is automatically set as a destination in the automobile navigation system 1; and with respect to this destination, a guided route is also retrieved and presented to the user. In this case, the user can directly choose an automatically set destination. If the user is not satisfied with an automatically set destination, he/she can change the setting.

Further, the present invention may be so constructed that the following is implemented: when a predetermined time has lapsed after the engine of the vehicle was started and the vehicle started running, a trigger signal is supplied to the control circuit 2; and the vehicular swept path during this period is taken into account when priorities are computed and a destination is automatically set. When the vehicle is heading substantially northward, for example, priorities are computed with respect to candidates located within a predetermined range with the north at the center. In this case, an optimum destination reflecting the direction to which the vehicle will be headed from now can be set based on the above vehicular swept path.

The period of time may be divided into, for example, three, “morning, daytime, and nighttime”, or four, “morning, daytime, evening, and nighttime.”

As situation items, aside from the foregoing, year, holiday, weather, ambient temperature, or the like may be set. Month, day of the week, or period of time need not be set as a situation item, and instead, an item deemed to be necessary may be chosen and set as appropriate.

In the above embodiments, a number of visits to a destination is counted. An intermediate point or stopping point at which the driver made a stop on the way to a set destination may be counted. At this time, it is advisable to count a point at which turn-off of the engine is detected before arrival at the destination or a point at which door open is detected before arrival at the destination.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

(Aspects)

Aspects of the disclosure described herein are set out in the following clauses.

As an aspect of the disclosure, a navigation system for a vehicle is provided as follows. A visit information recording unit is configured to record each visit point included in a plurality of visit points visited by a user, the each visit point being recorded in association with (i) visit situation information about each visit situation item included in a plurality of visit situation items, in which the user visited the each visit point, and (ii) a visit number of times the user visited the each visit point in the each visit situation item. A priority computing unit is configured to (i) designate, from the recorded visit points, visit points associated with visit situation items conforming to a trigger situation in which a predetermined trigger signal is supplied and (ii) compute a priority for each of the designated visit points, based on a visit number of times with respect to each visit situation item included in the visit situation items conforming to the trigger situation. A visit point information presenting unit is configured to present, based on the computed priorities of the designated visit points, visit point information for the user to choose a visit point for a subsequent driving.

Thus, information recorded by the visit information recording unit indicates in what situation a visit point the user visited in the past was frequently chosen. Therefore, the priority of a visit point is computed based on a number of visits conforming to the situation in which the trigger signal was supplied. As a result, the priority of a visit point conforming to the user's past behavioral pattern is higher. Therefore, when information for choosing a visit point is presented according to the level of priority, there is a higher possibility that the user thinks the presented information to conform to the situation at that time. Therefore, the user can easily choose a visit point more properly conforming to his/her own behavioral pattern.

As another optional aspect, the above visit situation information may contain the month, day of the week, and period of time when the above visit point was set. Therefore, recorded information about visit points can indicate a tendency for the user about the number of visits with respect to each month, day of the week, and period of time. Priorities can be computed based on these pieces of information.

As another optional aspect, the priority computing unit may be configured to compute a situation priority with respect to the each visit point by (i) multiplying a visit number of times, which is associated with the each visit situation item conforming to the trigger situation, by a situation weighting factor set to the each visit situation item to thereby obtain a multiplication product and (ii) further adding all the multiplication products with respect to the visit situation items conforming to the trigger situation. Therefore, it is possible to carry out computation so that the levels of situation priority are determined according to weights respectively set for multiple situation items.

Further in the above, the priority computing unit may be configured to compute an ultimate priority with respect to the each visit point by (i) evaluating a distance value corresponding to a distance from a present position of the vehicle to the each visit point, (ii) multiplying the situation priority by a weighting factor to thereby obtain a multiplication product, (iii) dividing a weighting factor by the evaluated distance value to thereby obtain a quotient, and (iv) adding the multiplication product and the quotient. That is, when ultimate priorities are computed, the distance to each visit point for which a situation priority is to be computed is also taken into account. Therefore, priorities can be more appropriately set.

Yet further in the above, the priority computing unit may select some from among highly ranked situation priorities and compute ultimate priorities with respect to them. This makes it possible to limit the number of objects of computation and shorten a processing time.

Yet further, the trigger signal may be supplied when a request to present an intermediate point candidate is inputted by the user after at least one visit point is previously designated as an ultimate point, wherein a priority with respect to the ultimate point was computed. The priority computing unit may be configured to compute a situation priority with respect to the intermediate point candidate by (i) multiplying a visit number of times, which is associated with each visit situation item conforming to the trigger situation, by a situation weighting factor set to the each visit situation item to thereby obtain a multiplication product and (ii) further adding all the multiplication products with respect to the visit situation items conforming to the trigger situation. The priority computing unit may be further configured to (i) evaluate a first distance value corresponding to a first distance between a present position of the vehicle and the intermediate point candidate and (ii) evaluate a second distance value corresponding to a second distance between the intermediate point candidate and the ultimate point. The priority computing unit may be further configured compute an intermediate point priority by (i) multiplying the situation priority with respect to the intermediate point candidate by a weighting factor to thereby obtain a multiplication product as a first result, (ii) dividing a weighting factor by the evaluated first distance value to thereby obtain a first quotient, (iii) dividing a weighting factor by the evaluated second distance value to thereby obtain a second quotient, and (iv) adding the multiplication product, the first quotient, and the second quotient.

More specific description will be given. When an ultimate point has been established and the user desires to stray from the route thereto, the priority computing unit carries out the following processing: it evaluates the distance between the present position of the vehicle and each intermediate point candidate and the distance between each intermediate point candidate and the ultimate point; and it computes the priorities of the intermediate point candidates conforming to the situation at that time. Therefore, the visit point information presenting unit can appropriately present information about intermediate point candidates based on the priorities.

Further in the above, the priority computing unit may select some from among the highly ranked situation priorities and carry out the above computation with respect thereto. Therefore, it is possible to limit the number of objects of computation and shorten a processing time.

Yet further, the trigger signal may be supplied when a request to present an ultimate point candidate is inputted by the user after at least one visit point is previously designated as a first visit point, wherein a priority with respect to the first visit point was computed. The priority computing unit may be configured to compute a situation priority with respect to the ultimate point candidate by (i) multiplying a visit number of times, which is associated with each visit situation item conforming to the trigger situation, by a situation weighting factor set to the each visit situation item to thereby obtain a multiplication product and (ii) further adding all the multiplication products with respect to the visit situation items conforming to the trigger situation. The priority computing unit may be further configured evaluate a distance value corresponding to a distance between a present position of the vehicle and the ultimate point candidate, and compute an ultimate point priority by (i) multiplying the situation priority with respect to the ultimate point candidate by a weighting factor to thereby obtain a multiplication product, (ii) dividing a weighting factor by the evaluated distance value to thereby obtain a quotient, and (iii) adding the multiplication product and the quotient.

More specific description will be given. When a user desires to take an already set visit point as an intermediate point and set a new visit point or destination therebeyond, the priority computing unit carries out the following processing: it evaluates the distance to the already set visit point and computes the priorities of ultimate point candidates conforming to the situation at that time. Therefore, the visit point information presenting unit can appropriately present information about ultimate point candidates based on the priorities.

Yet further, the priority computing unit may carry out learning based on the result of a user's actually setting a visit point and updates a weighting factor so that it is optimized. Therefore, it is possible to correct a priority to a value reflecting the result of the actual choice by the user, and the user can feel more comfortable in use.

As another optional aspect, the priority computing unit may be configured to, with respect to the each visit point, (i) multiply a visit number of times, which is associated with the each visit situation item conforming to the trigger situation, by a weighting factor set to the each visit situation item to thereby obtain a multiplication product and (ii) further add all the multiplication products with respect to the visit situation items conforming to the trigger situation to thereby obtain a first result. The priority computing unit may be further configured to, with respect to the each visit point, (i) evaluate a distance value corresponding to a distance from a present position of the vehicle to the each visit point, (ii) divide a weighting factor by the evaluated distance value to thereby obtain a second result. The priority computing unit may be yet further configured to compute the priority with respect to the each visit point by adding the first result and the second result. Therefore, it is possible to set priorities with the distance to each visit point taken into account from the beginning.

As another aspect, the trigger signal may be supplied when a request to present visit point candidates is inputted by the user; and the visit point information presenting unit may be configured to display visit point candidates in a list on a displaying unit in a descending order of priorities of the visit point candidates. Therefore, the user can choose a visit point he/she should choose from the list.

As another aspect, the trigger signal may be supplied when a request to present visit point candidates is not inputted within a predetermined time after startup. When a visit point candidate having a priority highly ranked is positioned on a map screen, which includes a current position of the vehicle, on a displaying unit, the visit point information presenting unit may be configured to display in an emphasized manner the visit point candidate having the-priority highly ranked. Therefore, even when the user does not expressly show a request to present visit point candidates, the user can choose a visit point candidate whose priority is highly ranked from the map screen image displayed at that time.

In the above, when the visit point candidate having the priority highly ranked cannot be displayed on the map screen image, the visit point information presenting unit may be configured to display on the map screen image a direction to which the visit point candidate is located. Therefore, even when a user desires to choose a candidate positioned out of a screen image, he/she can choose it based on the display.

As another optional aspect, the trigger signal may be supplied when a starting signal for an engine of the vehicle is supplied. The visit point information presenting unit may be configured to automatically designate a visit point candidate having a highest priority as a visit point and then searches for a guide route to the visit point. Therefore, the user can directly choose an automatically set visit point.

As another optional aspect, the trigger signal may be supplied when a predetermine time has lapsed after an engine of the vehicle was started and the vehicle started running. The visit point information presenting unit may be configured to automatically designate a visit point candidate having a highest priority as a visit point and then searches for a guide route to the visit point.

As another optional aspect, the priority computing unit may take into account the swept path of the vehicle until a predetermined time has lapsed after the vehicle started running when computing priorities. Therefore, it is possible to set an optimum visit point incorporating a direction to which the vehicle will be headed from now based on the vehicular swept path.

As another optional aspect, the visit point may include a destination designated by the user; yet alternatively, the visit point may include (i) a destination designated by the user and (ii) an intermediate point at which the vehicle stops before reaching the destination.

It will be obvious to those skilled in the art that various changes may be made in the above-described embodiments of the present invention. However, the scope of the present invention should be determined by the following claims.

What is claimed is:

1. A navigation system for a vehicle, the system comprising:
a visit information recording unit configured to record each visit point included in a plurality of visit points visited by a user, the each visit point being recorded in association with (i) visit situation information about each visit situation item included in a plurality of visit situation items, in which the user visited the each visit point, and (ii) a visit number of times the user visited the each visit point in the each visit situation item;
a priority computing unit configured to
designate, from the recorded visit points, visit points associated with visit situation items conforming to a trigger situation in which a predetermined trigger signal is supplied and
compute a priority for each of the designated visit points, based on a visit number of times with respect to each visit situation item included in the visit situation items conforming to the trigger situation; and
a visit point information presenting unit configured to present, based on the computed priorities of the designated visit points, visit point information for the user to choose a visit point for a subsequent driving.

2. The navigation system according to claim 1, wherein
the visit situation information includes, as a visit situation item, a month when the visit point was visited.

3. The navigation system according to claim 1, wherein
the visit situation information includes, as a visit situation item, a day of a week when the visit point was visited.

4. The navigation system according to claim 1, wherein
the visit situation information includes, as a visit situation item, a period of time when the visit point was visited.

5. The navigation system according to claim 1, wherein
the priority computing unit is configured to compute a situation priority with respect to the each visit point by (i) multiplying a visit number of times, which is associated with the each visit situation item conforming to the trigger situation, by a situation weighting factor set to the each visit situation item to thereby obtain a multiplication product and (ii) further adding all the multiplication products with respect to the visit situation items conforming to the trigger situation.

6. The navigation system according to claim 5, wherein
the priority computing unit is configured to compute an ultimate priority with respect to the each visit point by (i) evaluating a distance value corresponding to a distance from a present position of the vehicle to the each visit point, (ii) multiplying the situation priority by a weighting factor to thereby obtain a multiplication product, (iii) dividing a weighting factor by the evaluated distance value to thereby obtain a quotient, and (iv) adding the multiplication product and the quotient.

7. The navigation system according to claim 6, wherein
the priority computing unit is configured to select visit points, which have highly ranked situation priorities from among the visit points associated with the visit situation items conforming to the trigger situation, and compute the ultimate priority with respect to each visit point included in the selected visit points.

8. The navigation system according to claim 5, wherein;
the trigger signal is supplied when a request to present an intermediate point candidate is inputted by the user after at least one visit point is previously designated as an ultimate point, wherein a priority with respect to the ultimate point was computed; and
the priority computing unit is configured to
compute a situation priority with respect to the intermediate point candidate by (i) multiplying a visit number of times, which is associated with each visit situation item conforming to the trigger situation, by a situation weighting factor set to the each visit situation item to thereby obtain a multiplication product and (ii) further adding all the multiplication products with respect to the visit situation items conforming to the trigger situation,
evaluate a first distance value corresponding to a first distance between a present position of the vehicle and the intermediate point candidate,
evaluate a second distance value corresponding to a second distance between the intermediate point candidate and the ultimate visit point, and
compute an intermediate point priority by (i) multiplying the situation priority with respect to the intermediate point candidate by a weighting factor to thereby obtain a multiplication product as a first result, (ii) dividing a weighting factor by the evaluated first distance value to thereby obtain a first quotient, (iii) dividing a weighting factor by the evaluated second distance value to thereby obtain a second quotient, and (iv) adding the multiplication product, the first quotient, and the second quotient.

9. The navigation system according to claim 8, wherein
the priority computing unit is configured to select visit points having highly ranked situation priorities from among the visit points associated with the visit situation items conforming to the trigger situation and then compute an ultimate priority with respect to each visit point included in the selected visit points.

10. The navigation system according to claim 5, wherein:
the trigger signal is supplied when a request to present an ultimate point candidate is inputted by the user after at least one visit point is previously designated as a first visit point, wherein a priority with respect to the first visit point was computed; and
the priority computing unit is configured to
compute a situation priority with respect to the ultimate point candidate by (i) multiplying a visit number of times, which is associated with each visit situation item conforming to the trigger situation, by a situation weighting factor set to the each visit situation item to thereby obtain a multiplication product and (ii) further adding all the multiplication products with respect to the visit situation items conforming to the trigger situation,
evaluate a distance value corresponding to a distance between a present position of the vehicle and the ultimate point candidate, and
compute an ultimate point priority by (i) multiplying the situation priority with respect to the ultimate point candidate by a weighting factor to thereby obtain a multiplication product, (ii) dividing a weighting factor by the evaluated distance value to thereby obtain a quotient, and (iii) adding the multiplication product and the quotient.

11. The navigation system according to claim 5, wherein
the priority computing unit is configured to perform learning based on a result of a user's actually designating a visit point to thereby update and optimize a weighting factor.

12. The navigation system according to claim 1, wherein:
the priority computing unit is configured to, with respect to the each visit point, (i) multiply a visit number of times, which is associated with the each visit situation item conforming to the trigger situation, by a weighting factor set to the each visit situation item to thereby obtain a multiplication product and (ii) further add all the multiplication products with respect to the visit situation items conforming to the trigger situation to thereby obtain a first result;
the priority computing unit is configured to, with respect to the each visit point, (i) evaluate a distance value corresponding to a distance from a present position of the vehicle to the each visit point, (ii) divide a weighting factor by the evaluated distance value to thereby obtain a second result; and
the priority computing unit is configured to compute the priority with respect to the each visit point by adding the first result and the second result.

13. The navigation system according to claim 1, wherein:
the trigger signal is supplied when a request to present visit point candidates is inputted by the user; and
the visit point information presenting unit is configured to display visit point candidates in a list on a displaying unit in a descending order of priorities of the visit point candidates.

14. The navigation system according to claim 1, wherein:
the trigger signal is supplied when a request to present visit point candidates is not inputted within a predetermined time after startup; and
when a visit point candidate having a priority highly ranked is positioned on a map screen, which includes a current position of the vehicle, on a displaying unit, the visit point information presenting unit is configured to display in an emphasized manner the visit point candidate having the priority highly ranked.

15. The navigation system according to claim 14, wherein
when the visit point candidate having the priority highly ranked cannot be displayed on the map screen image, the visit point information presenting unit is configured to display on the map screen image a direction to which the visit point candidate is located.

16. The navigation system according to claim 1, wherein:
the trigger signal is supplied when a starting signal for an engine of the vehicle is supplied; and
the visit point information presenting unit is configured to automatically designate a visit point candidate having a highest priority as a visit point and then searches for a guide route to the visit point.

17. The navigation system according to claim 1, wherein:
the trigger signal is supplied when a predetermine time has lapsed after an engine of the vehicle was started and the vehicle started running; and
the visit point information presenting unit is configured to automatically designate a visit point candidate having a highest priority as a visit point and then searches for a guide route to the visit point.

18. The navigation system according to claim 17, wherein
the priority computing unit is configured to take into account a swept path of the vehicle until a predetermined time has lapsed after the vehicle started running when computing the priority.

19. The navigation system according to claim 1, wherein
the visit point includes a destination designated by the user.

20. The navigation system according to claim 1, wherein
the visit point includes (i) a destination designated by the user and (ii) an intermediate point at which the vehicle stops before reaching the destination.
